(19) United States
(12) Patent Application Publication
(10) Pub. No.: US 2026/0054290 A1
(43) Pub. Date: Feb. 26, 2026

(54) DEVICE FOR CONTROLLING AN ULTRASONIC TRANSDUCER FOR GENERATING ULTRASONIC WAVES

(71) Applicant: ELMOS Semiconductor SE, Leverkusen (DE)

(72) Inventors: Dennis Kreiß, Hannover (DE); Andre Schmidt, Wiehl (DE); Stefanie Heppekausen, Essen (DE); Egbert Spiegel, Marl (DE)

(73) Assignee: ELMOS Semiconductor SE, Leverkusen (DE)

(21) Appl. No.: 19/299,197

(22) Filed: Aug. 13, 2025

(30) Foreign Application Priority Data
Aug. 21, 2024 (DE) 102024123913.1

(51) Int. Cl. B06B 1/02; H02M 7/537

(52) U.S. Cl. CPC B06B 1/0215; H02M 7/537

(57) ABSTRACT

A device for controlling an ultrasonic transducer, includes: a transformer including a first primary-side terminal and a second primary-side terminal, and two secondary-side terminals, to which an ultrasonic transducer can be connected; a first low-side switch arranged between a first node and the first primary-side terminal of the transformer, and a second low-side switch is arranged between the first circuit node, and the second primary-side terminal of the transformer; a first high-side switch arranged between a second node and a first primary-side terminal of the transformer, and a second high-side switch arranged between the second node and a second primary-side terminal of the transformer; and a switch control unit for alternating switching the high-side switches and the low-side switches. An energy source with two terminals can be connected directly or indirectly to the first node and the second node. The switch control unit switches between first and second control phases.

### CROSS REFERENCE TO RELATED APPLICATIONS

The present patent application is a US Non-Provisional patent application claiming priority to and the benefit of German patent application DE 10 2024 123 913.1 filed on Aug. 21, 2024, the disclosure of which is incorporated in the present patent application by reference.

### TECHNICAL FIELD

The disclosure relates to a device for controlling an ultrasonic transducer for generating ultrasonic waves.

### BACKGROUND

Ultrasonic transducers of this type are used, for example, to monitor the surroundings of a vehicle. For this purpose, several ultrasonic transducers are typically connected via a communication bus to a central control unit which, in addition to controlling the ultrasonic transducers or controlling their control devices, also evaluates the ultrasonic signals received from the ultrasonic transducers, with each ultrasonic transducer typically providing pre-processing of the received ultrasonic signals with the aid of electronics assigned to it. In this respect, the ultrasonic transducer is part of an ultrasonic sensor, so to speak, which, in addition to the control device, also provides circuit components for the pre-processing and, if necessary, partial evaluation of the electro-acoustic signals. These sensors can also perform self-tests or similar self-diagnostics.

In order to generate ultrasonic waves with the sound pressure required for monitoring the surroundings of a vehicle, for example, using an ultrasonic transducer, a considerable amount of energy and power is usually required to control the ultrasonic transducer. The ultrasonic transducers are therefore controlled via transformers. One of the advantages of this is that the voltage capability of the components of integrated circuits, such as those typically used for ultrasonic sensors, only needs to be comparatively low, as the voltage for the ultrasonic transducer is upward transformed via the transformer.

In prior art, it is known to alternatingly and alternately connect the primary-side coil of a transformer for controlling an ultrasonic transducer to a common potential or to a current source via one of two semiconductor switches (e.g. transistors). The current paths of these two semiconductor switches are controlled via a control unit, in opposite directions and alternately. The primary-side coil also has a center tap that is connected to a supply potential. The alternately opposing control of the two semiconductor switches results in a current that alternately changes direction in the primary-side coil and flows through the primary-side coil between one of the primary-side terminals and the center tap. The required changeover drive voltage (also known as AC drive voltage) for the ultrasonic transducer (see e.g. EP-A-2 189 808) is then obtained at its secondary-side terminals by selecting the appropriate transmission ratio of the transformer.

The design of the transformer with a primary-side center tap involves a certain amount of effort, as two windings (coils) are required, the connection between which must be led out as a center tap. The center tap further requires an additional terminal on the IC. All this increases the manufacturing and/or assembly costs of the ultrasonic sensor.

### SUMMARY

It is an object of the disclosure is to provide a remedy in this respect and to provide a simplified structure and connection for an ultrasonic transducer.

To achieve this object, the disclosure provides a device for controlling an ultrasonic transducer for generating ultrasonic waves, the device being provided with:
a transformer which has a first and a second primary-side terminal (with a primary-side coil between these terminals) and two secondary-side terminals (with a secondary-side coil between them) to which an ultrasonic transducer can be connected,
a first and a second low-side semiconductor switch, each of which has a current path that can be switched to be either conducting or non-conducting,
wherein the current path of the first low-side semiconductor switch is arranged between a first circuit node common to the two low-side semiconductor switches and the first primary-side terminal of the transformer and the current path of the second low-side semiconductor switch is arranged between the first circuit node and the second primary-side terminal of the transformer,
a first and a second high-side semiconductor switch, each of which has a current path that can be switched to be either conducting or non-conducting,
wherein the current path of the first high-side semiconductor switch is arranged between a second circuit node common to the two high-side semiconductor switches and the first primary-side terminal of the transformer and the current path of the second high-side semiconductor switch is arranged between the second circuit node and the second primary-side terminal of the transformer,
wherein an energy source with two terminals can be connected directly or indirectly to the two circuit nodes, and
a switch control unit for alternating switching the high-side semiconductor switches and the low-side semiconductor switches to be conducting or non-conducting,
wherein the switch control unit switches the first high-side semiconductor switch and the second low-side semiconductor switch to be conducting and the second high-side semiconductor switch and the first low-side semiconductor switch to be non-conducting in one control phase of a control cycle and switches the second high-side semiconductor switch and the first low-side semiconductor switch to be conducting and the first high-side semiconductor switch and the second low side semiconductor switch to be non-conducting in another control phase of the control cycle, wherein current flows alternately in opposite directions through the primary-side terminals of the transformer and thus through its primary-side coil.

The starting point for the approach of the disclosure for an improvement in the control of an ultrasonic transducer by simplifying the design of the transformer is the known connection of the two primary-side terminals of the transformer with a respective semiconductor switch, referred to below as a low-side semiconductor switch, whose current paths lead from a common first circuit node to the two primary-side terminals. Further, two high-side semiconductor switches are connected, according to the disclosure, to the two primary-side terminals of the transformer, the current paths of which lead from the two primary-side terminals of the transformer to a common second circuit node. The current paths of all semiconductor switches, which are typically transistors, can now be switched alternately to be conducting and non-conducting, which means that current flows alternately in opposite directions through the primary-side terminals of the transformer and thus through its primary-side coil, which is arranged between the two series circuits each including a low-side semiconductor switch and a high-side semiconductor switch.

Of the two series circuits connected in parallel, each including two semiconductor switches, the first series circuit has the current paths of the first low-side semiconductor switch and the first high-side semiconductor switch, while the second series circuit has the current paths of the second low-side semiconductor switch and the second high-side semiconductor switch. The primary-side terminals of the transformer are connected to the respective connection nodes between the two semiconductor switch current paths of each series circuit. The current paths of the four semiconductor switches is performed such that the switch control unit switches the first high-side semiconductor switch and the second low-side semiconductor switch to be conducting and the second high-side semiconductor switch and the first low-side semiconductor switch to be non-conducting in one control phase of a control cycle and switches the second high-side semiconductor switch and the first low-side semiconductor switch to be conducting and the first high-side semiconductor switch and the second low side semiconductor switch to be non-conducting in another control phase of the control cycle, wherein current flows alternately in opposite directions through the primary-side terminals of the transformer and thus through its primary-side coil.

A major advantage of the disclosure is that the design of the transformer is simplified, as the center tap of the primary-side coil can be dispensed with and thus only one (single) winding or coil is required on the primary side. Furthermore, a terminal on the IC can be saved.

In an advantageous example of the disclosure, the device further comprises a current source for setting the current flowing via the current paths of the high-side semiconductor switches and the low-side semiconductor switches into their respective conductive states, wherein the current source is arranged between the first circuit node and one terminal of the two terminals of the energy source or between the second circuit node and the other terminal of the two terminals of the energy source. The current source can now be used to set the current that flows via the current paths of the semiconductor switches. This is particularly advantageous if, as is typically the case, several ultrasonic transducers are used to monitor the surroundings of a vehicle. Due to manufacturing tolerances of both the ultrasonic transducers and the transformers, it is not necessarily ensured that all transducers emit ultrasonic waves with the same sound pressure when they are connected to the vehicle electrical system and operated. However, this is an advantage when it comes to reliably monitoring the vehicle's surroundings. Therefore, by adjusting the current source, each ultrasonic transducer can now be controlled in such a way that all ultrasonic transducers emit sonic waves with essentially the same sound pressure.

The current source per ultrasonic transducer used with advantage in this respect can now be connected either to the high-side semiconductor switches (so-called high-side current source) or to the current paths of the low-side semiconductor switches (so-called low-side current source). In both cases, the current source is therefore connected to one of the two circuit nodes, while the other circuit node is connected to, for example, ground potential if the current source is used as a high-side current source and to the supply potential of the vehicle electrical system if the current source is used as a low-side current source.

The control of the primary side of the transformer according to the disclosure, in combination with a higher supply voltage of this control, results in a reduction/halving of the current compared to transformers with a center tap on the primary side, which means that the semiconductor switches used must be designed to be significantly smaller and therefore also require a smaller chip area. In addition, the space for the high-voltage IC pin of the center tap can be saved. Finally, the diagnosis of the control unit is also simplified. As far as the simplification of the transformer is concerned, two primary-side windings/coils can be dispensed with in accordance with the disclosure and a single coil can be used instead.

For the OEM's supplier, who supplies the ultrasonic sensors or the individual sensor modules, there are further advantages in which, for example, simpler routing is possible on the PCB, as only two lines need to be routed from the IC to the transformer (compared to three lines with the center tap of the transformers previously used). The halving of the current mentioned above also means lower ohmic losses, so that less power is lost and the transformer can be operated more efficiently. In view of the fact that transformers currently in use already reach their inductive saturation at higher currents (approx. 500 mA), there are also significantly more reserves for the supplier due to the halving of the current. Halving the current also leads to reduced EMC radiation on the supply lines.

However, the supplier can also use the control device according to the disclosure without changing the design of the transformers previously used. For this purpose, it dispenses with the connection of the center tap to the control unit and connects the two “outer” primary-side connections to the control unit. This procedure applies in particular if half the transmission ratio is to be used, e.g. 1:5 instead of 1:10. However, the supplier also has the option of using an optimized transformer that does not require a center tap on the primary side. This reduces the cost of manufacturing the transformer.

In this respect, in order to achieve the above object, it is alternatively proposed according to the disclosure that the control device is provided with:
a first and a second low-side semiconductor switch, each of which has a current path that can be switched to be either conducting or non-conducting,
wherein the current path of the first low-side semiconductor switch is arranged between a first circuit node common to the two low-side semiconductor switches and a first output terminal which is connectable to a first primary-side terminal of a transformer connected to the ultrasonic transducer, and the current path of the second low-side semiconductor switch is arranged between the first circuit node and a second output terminal which is connectable to a second primary-side terminal of said ultrasonic transducer,
a first and a second low-side semiconductor switch, each of which has a current path that can be switched to be either conducting or non-conducting,
wherein the current path of the first high-side semiconductor switch is arranged between a second circuit node common to the two high-side semiconductor switches and the first output terminal and the current path of the second high-side semiconductor switch is arranged between the second circuit node and the second output terminal,
wherein an energy source with two terminals can be connected directly or indirectly to the two circuit nodes, and
a switch control unit for alternating switching the high-side semiconductor switches and the low-side semiconductor switches to be conducting or non-conducting,
wherein the switch control unit switches the first high-side semiconductor switch and the second low-side semiconductor switch to be conducting and the second high-side semiconductor switch and the first low-side semiconductor switch to be non-conducting in one control phase of a control cycle and switches the second high-side semiconductor switch and the first low-side semiconductor switch to be conducting and the first high-side semiconductor switch and second low side semiconductor switch to be non-conducting in another control phase of the control cycle.

### BRIEF DESCRIPTION OF THE DRAWINGS

FIG. 1 illustrates an example circuit for an ultrasonic sensor according to the disclosure.

### DESCRIPTION

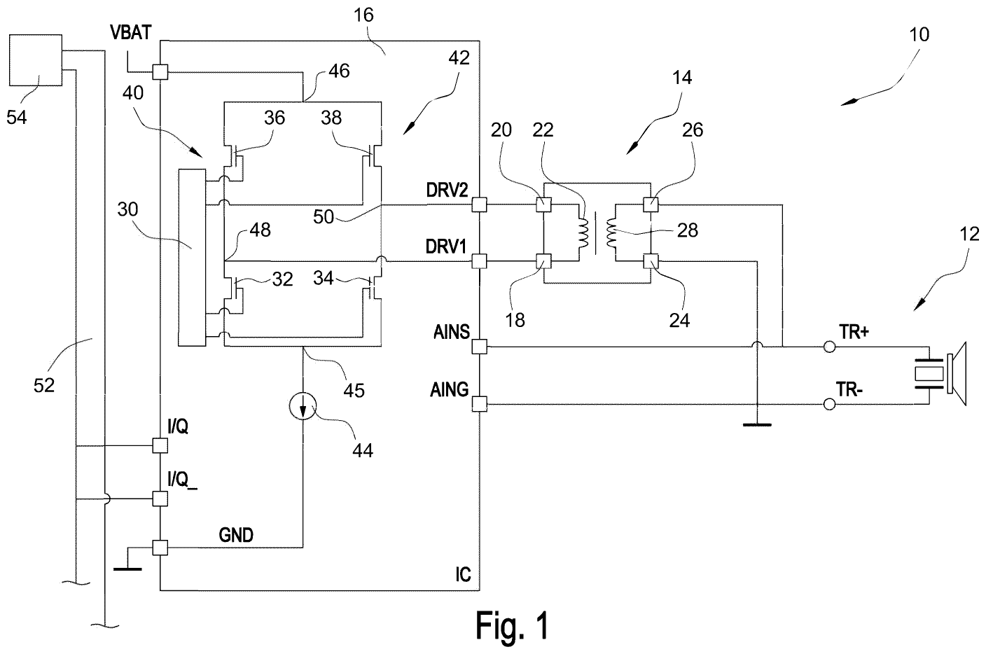

The FIGURES (FIG. 1) shows an embodiment of the disclosure. The overall structure of an ultrasonic sensor 10 is shown schematically, which has an ultrasonic transducer 12, a transformer 14 supplying the ultrasonic

The transformer 14 has a first primary-side terminal 18 and a second primary-side terminal 20 with a primary-side coil or winding 22 between these two terminals. On the secondary side, the transformer 14 has a first output terminal 24 and a second output terminal 26 with a secondary-side coil or winding 28 between the two. The two secondary-side terminals 24, 26 are connected to the TR− and TR+ terminals of the ultrasonic transducer 12.

Part of the control unit 16 is a switch control unit 30 for the conducting and non-conducting switching of a total of four semiconductor switches. In this case, the current path of a first low-side semiconductor switch 32 is connected to the current path of a first high-side semiconductor switch 36 to form a first series circuit 40, while the current path of a second low-side semiconductor switch 34 is connected to the current path of a second high-side semiconductor switch 38 to form a second series circuit 42. Both series circuits are connected between a supply potential VBAT and, in this embodiment example, a current source 44, which in turn is connected to a second voltage potential (for example, ground potential) GND. The two low-side semiconductor switches 32 and 34 are thus connected to a first circuit node 45 and the two high-side semiconductor switches 36, 38 are connected to a second circuit node 46. The connection node 48 of the two semiconductor switches of the first series circuit 40 is connected to the first primary-side terminal 18 of the transformer 14 as an outwardly routed terminal (for example, first output terminal) DRV1 of the control unit 16. In a corresponding manner, the connection node 50 of the semiconductor switches of the second series circuit 42 is connected to the second primary-side terminal 20 of the transformer 14 as an outwardly routed terminal (for example, second output terminal) DRV2.

The Figures also show that the two terminals TR+ and TR− of the ultrasonic transducer 12 are connected to two receive signal terminals AINS and AING of the control unit 16. Via these two IC terminals, the electrical received signal, which the ultrasonic transducer generates in response to a received echo, reaches circuit components, which are no longer shown, for the purpose of pre-processing the received signal, which after its pre-processing is routed to the outside via the other IC terminals (e.g. for communication and external control) (for example, communication bus terminals) I/Q and I/Q_, for example via a communication bus 52 to a central control and evaluation unit 54.

Not shown in the Figures are external and internal components that ensure decoupling of the high-voltage control signals for the ultrasonic transducer and its low-voltage receive signals. Such measures and circuit components are generally known in connection with the operation of ultrasonic transducers and therefore do not require further explanation here.

The disclosure was described above together with the transformer as a component of the control device of the ultrasonic transducers. However, the disclosure also manifests itself without reference to the transformer. In this respect, the disclosure thus relates to a control device of an ultrasonic transducer for generating ultrasonic waves, which comprises the said four semiconductor switches with their interconnection described above and the switch control unit for alternately switching the semiconductor switches conducting or non-conducting, as also described above.

### LIST OF REFERENCE NUMERALS

10 sensor
12 ultrasonic transducer
14 transformer
16 control unit (as IC)
18 first primary-side terminal
20 second primary-side terminal
22 primary-side coil or winding
24 first secondary-side terminal
26 second secondary-side terminal
28 secondary-side coil or winding
30 switch control unit
32 first low-side semiconductor switch
34 second low-side semiconductor switch
36 first high-side semiconductor switch
38 second high-side semiconductor switch
40 first series circuit
42 second series circuit
44 current source
45 first circuit node
46 second circuit node
48 connection node
50 connection node
52 communication bus
54 central control and evaluation unit
DRV1 first output terminal
DRV2 second output terminal
AINS receive signal terminal
AING receive signal terminal
I/Q_ communication bus terminal
I/Q communication bus terminal
VBAT supply potential of the energy source
GND ground potential of the energy source

What is claimed is:

1. A device for controlling an ultrasonic transducer (12) for generating ultrasonic waves, comprising:
a transformer (14) including a first primary-side terminal (18) and a second primary-side terminal (20), and two secondary-side terminals (24, 26), to which an ultrasonic transducer can be connected;
a first low-side semiconductor switch (32) and a second low-side semiconductor switch (34), wherein each of the first low-side semiconductor switch (32) and the second low-side semiconductor switch (34) includes a respective current path that can be switched to be either conducting or non-conducting, wherein the current path of the first low-side semiconductor switch (32) is arranged between a first circuit node (45) common to the first low-side semiconductor switch (32) and the second low-side semiconductor switch, and the first primary-side terminal (18) of the transformer, and the current path of the second low-side semiconductor switch (34) is arranged between the first circuit node (45) common to the first low-side semiconductor switch (32) and the second low-side semiconductor switch (34), and the second primary-side terminal (20) of the transformer;
a first high-side semiconductor switch (36) and a second high-side semiconductor switch (38), wherein each of first high-side semiconductor switch (36) and the second high-side semiconductor switch (38) includes a respective current path that can be switched to be either conducting or non-conducting, wherein the current path of the first high-side semiconductor switch (36) is arranged between a second circuit node (46) common to the first high-side semiconductor switch (36) and the second high-side semiconductor switch (38), and a first primary-side terminal (18) of the transformer (14), and the current path of the second high-side semiconductor switch (38) is arranged between the second circuit node (46) and a second primary-side terminal (20) of the transformer; and
a switch control unit for alternating switching the high-side semiconductor switches and the low-side semiconductor switches to be conducting or non-conducting;
wherein:
an energy source (VBAT, GND) with two terminals can be connected directly or indirectly to the first circuit node (45) and the second circuit node (46); and
the switch control unit switches the first high-side semiconductor switch (36) and the second low-side semiconductor switch (34) to be conducting and the second high-side semiconductor switch (38) and the first low-side semiconductor switch (32) to be non-conducting in one control phase of a control cycle and switches the second high-side semiconductor switch (38) and the first low-side semiconductor switch (32) to be conducting and the first high-side semiconductor switch (36) and the second low-side semiconductor switch (34) to be non-conducting in another control phase the control cycle.

2. A device for controlling an ultrasonic transducer (12) for generating ultrasonic waves, comprising:
a first low-side semiconductor switch (32) and a second low-side semiconductor switch (34), wherein each of the first low-side semiconductor switch (32) and the second low-side semiconductor switch (34) includes a respective current path that can be switched to be either conducting or non-conducting, wherein the current path of the first low-side semiconductor switch (32) is arranged between a first circuit node (45) common to the first low-side semiconductor switch (32) and the second low-side semiconductor switch (34), and a first output terminal (DVR1), which is connectable to a first primary-side terminal (18) of a transformer (14) connected to the ultrasonic transducer (12), and the current path of the second low-side semiconductor switch (34) is arranged between the first circuit node (45) and a second output terminal (DRV2) which is connectable to a second primary-side terminal (20) of said transformer (14);
a first high-side semiconductor switch (36) and a second high-side semiconductor switch (38), wherein each of the first high-side semiconductor switch (36) and the second high-side semiconductor switch (38) includes a respective current path that can be switched to be either conducting or non-conducting, wherein the current path of the first high-side semiconductor switch (36) is arranged between a second circuit node (46) common to the first high-side semiconductor switch (36) and the second high-side semiconductor switch (38), and the first output terminal (DRV1), and the current path of the second high-side semiconductor switch (38) is arranged between the second circuit node (46) and the second terminal (DRV2); and
a switch control unit for alternating switching the first high-side semiconductor switch (36) and the second high-side semiconductor switch (38) and the low-side semiconductor switches (32, 34) to be conducting or non-conducting;
wherein:
an energy source (VBAT, GND) with two terminals can be connected directly or indirectly to the two circuit nodes (45, 46); and
the switch control unit (30) switches the first high-side semiconductor switch (36) and the second low-side semiconductor switch (34) to be conducting and the second high-side semiconductor switch (38) and the first low-side semiconductor switch (32) to be non-conducting in one control phase of a control cycle and switches the second high-side semiconductor switch (38) and the first low-side semiconductor switch (32) to be conducting and the first high-side semiconductor switch (36) and the second low-side semiconductor switch (34) to be non-conducting in another control phase the control cycle.

3. The device according to claim 1, including a current source (44) for setting a current flowing via the current paths of the first high-side semiconductor switch (36) and the second high-side semiconductor switch (38) and the first low-side semiconductor switch (32) and the second low-side semiconductor switch (34) to their respective conducting end states, the current source (44) being arranged between the first circuit node (45) and the one terminal of the energy source (VBAT, GND) or between the second circuit node (46) and the other terminal of the energy source (VBAT, GND).

4. The device according to claim 2, including a current source (44) for setting a current flowing via the current paths of the first high-side semiconductor switch (36) and the second high-side semiconductor switch (38) and the first low-side semiconductor switch (32) and the second low-side semiconductor switch (34) to their respective conducting end states, the current source (44) being arranged between the first circuit node (45) and the one terminal of the energy source (VBAT, GND) or between the second circuit node (46) and the other terminal of the energy source (VBAT, GND).
